(19) United States
(12) Patent Application Publication
(10) Pub. No.: US 2016/0117727 A1
(43) Pub. Date: Apr. 28, 2016

(54) ADAPTIVE RETARGETING

(71) Applicant: Yahoo! Inc., Sunnyvale, CA (US)

(72) Inventors: Bruce Campbell, Potters Bar (GB); Jonathan Avni, San Francisco, CA (US); Chloe Chen, London (GB)

(73) Assignee: YAHOO! INC., Sunnyvale, CA (US)

(21) Appl. No.: 14/524,773

(22) Filed: Oct. 27, 2014

(51) Int. Cl. G06Q 30/02

(52) U.S. Cl. CPC G06Q 30/0256

(57) ABSTRACT

Described herein are solutions for improving ad retargeting. For example, described herein are solutions for improving ad retargeting amongst various online marketing channels, such as search engine and native advertising marketing channels. The solutions can include adaptive ad retargeting. Adaptive ad retargeting can be beneficial in that it can solve the problem of ineffectively predicting which search terms to associate with advertising, such as in a more conventional process of selecting search terms in a search engine marketing campaign. Instead, for example, these technologies can identify behavior of individuals who have already interacted with certain advertising online, so that when similar behavior occurs by those individuals or other users, ads can be retargeted to such users effectively according to the similar behavior.

### BACKGROUND

This application relates to adaptive retargeting. For example, this application relates to adaptive retargeting of online ads according to historical user interaction with online media.

Increasingly, advertising is being integrated with online content. Online audiences are demanding free content or at least content delivered at below market prices. Because of this demand, publishers and content networks may be delivering ads with such content to compensate for lost profits. It has also been found that advertising can be acceptable to online audiences if the advertising is useful to audience members. Also, beyond being acceptable, advertising can be sought after by users if it is well targeted.

The common techniques of targeting advertising (including retargeting techniques) are helpful in increasing click through rates of ads, but such techniques could be improved considering the scale of online advertising and the growth of the mobile marketplace for advertising. There is, therefore, a set of engineering problems to be solved in order to provide ad targeting (which includes ad retargeting) that is well adapted to mobile and non-mobile online environments, so that such advertising is optimized.

Resolution of such engineering problems is pertinent considering the competitive landscape of online advertising. The resolution of these technical issues can benefit advertisers in providing more effective and efficient use of ad targeting (such as ad retargeting), which may result in a greater number of user interactions with their ads. The novel technologies described herein set out to solve the problem of determining who to retarget to and how to retarget those users, so to increase the probability that a targeted user will interact with advertising. The technologies also set out to solve the problem of matching ads to audience members that are more likely to interact with the ads than other audience members. With this last problem, included is the problem of determining meaningful relationships between ads and user interactions with online media. Today, there is room for improvement for resolving the aforementioned problems in online advertising.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can communicatively couple with an example system that can provide ad retargeting according to at least historical online interactions (such as online searches and interactions with advertising). Herein, such ad retargeting is also referred to as adaptive ad retargeting.

FIG. 2 illustrates displayed ad items and content items of example screens rendered by client-side applications. The displayed items may be provided through adaptive ad retargeting.

FIG. 3 illustrates a block diagram of example aspects of a system, such as the system in FIG. 1, which can provide adaptive retargeting.

FIGS. 4 and 5 illustrate example operations performed by a system, such as the systems in FIGS. 1 and 3, which can provide adaptive retargeting.

FIGS. 6 and 7 are block diagrams of example electronic devices that can implement aspects of and related to example systems that can provide adaptive retargeting.

### DETAILED DESCRIPTION

Subject matter will now be described more fully hereinafter with reference to the accompanying drawings, which form a part hereof, and which show, by way of illustration, specific examples. Subject matter may, however, be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### OVERVIEW

Before describing the subject matter more fully with reference to the drawings, this section provides an overview of examples of systems and operations for adaptive ad retargeting.

Ad retargeting can include the process of showing ads to people who have previously searched on specific search terms. Various online marketing channels, including search engine marketing channels and native advertising channels, can use ad retargeting. Some examples of the systems and operations described herein expand on ad retargeting by providing search results to a query including retargeted advertising according to historical interactions with ads by people that have made such a query in the past. This is one example of adaptive ad retargeting. Additionally or alternatively, those search results may not include retargeted advertising, but the retargeting can occur later to the same user who executed the query in different channels. For example, the retargeted advertising can be provided to the user through a native marketing channel. This example may include retargeted advertisements listed with streamed content. In such an example, the advertisements may appear as one of the streamed content items and may be distinguishable by a label indicating that the item is sponsored.

Adaptive ad retargeting can be beneficial in that it can solve the problem of ineffectively predicting which search terms to associate with advertising, such as in a more conventional process of selecting search terms in a search engine marketing campaign. Instead, for example, these technologies can identify behavior of individuals who have already interacted with certain advertising online, so that when similar behavior occurs by those individuals or other users, ads can be retargeted to such users effectively according to the similar behavior. In an example, online behavior, such as interactions with ads, can be measured by clicks on an item such as an ad item. In the example, such interactions can be logged as ad retargeting data. Also, online behaviors, such as search queries, can be logged as ad retargeting data. In an example, legacy data can also be used as ad retargeting data. For example, search histories can be collected if previously available.

The basis for connections between behaviors can be by user and session identifications. The systems and operations described herein can identify users and browser sessions of users in various ways. Login information, user profiles, cookies, digital certificates, or any combination thereof can identify users and sessions. For example, detailed user profiles can be generated and maintained per user and such profiles can be grouped by audience segments as well. The technologies described herein can group users by demographics, psychographics (such as by online behaviors), or both demographics and psychographics. Such profiles and groups can provide the relationships between behaviors, and such information can be logged as ad retargeting data.

Associations between any type of online interactions with ads and other online user behavior (implicit or explicit) before or after such ad interactions can be utilized by the technologies described herein, and such information can be logged as ad retargeting data. For example, behaviors can be inferred from online property impressions and can include various types of navigations to properties. For example, historical data on articles read online by a user can be used to retarget ads to similar behaving users. Also, associations can be made between ad clicks and searches. Also, in examples, relationships between behaviors and ads used for retargeting can be fine-tuned, and grouping of audience members by online behaviors can be fine-tuned. For example, an ad can be provided for “Bob's Bicycle Company” in a stream of online content. A user can click on the ad and the system can record the click. At a different time, before or after the ad click, the same user queries the Internet using search terms such as “bicycle”, “helmet”, and “mountain bike”. For example, the user can search these terms more frequently than the average user. At this point, the system can identify that at least this user and possibly users that belong to an audience segment of that user may click on the ad for “Bob's Bicycle” or a similar ad, such as a different ad for “Bob's Bicycle” or a competitor. Accordingly, such an identification can be used to retarget corresponding advertising. Ultimately, for example, the click through rate of the ad and similar ads may increase by the retargeting. Also, such systems and operations can be continually and automatically updated and optimized (i.e., fine-tuned) by success rates of the retargeting, so that interaction frequencies with the ad and similar ads can be further increased. Furthermore, an audience segment associated with the search terms can be fine-tuned as well to increase the effectiveness of the retargeting. Any information used for ad retargeting can be logged, stored, and communicated as ad retargeting data.

In yet another example, a server can run a first continuous process to capture user search history, which can result in an organic data set relating users to search terms. The server can also run a second continuous process to monitor frequencies with which users on selected Internet properties of a content and/or advertising network have searched on certain terms. The server can also run a third process to record search terms that are common among users of each ad on each Internet property of the network. Eventually, a connected ad server can provide ads according to any combination of intersections between recorded data logged by the first, second, and third continuous processes. The search terms collected through these processes and the other processes described herein may be normalized to provide a more effective database of search terms and associations.

### DESCRIPTION OF THE DRAWINGS

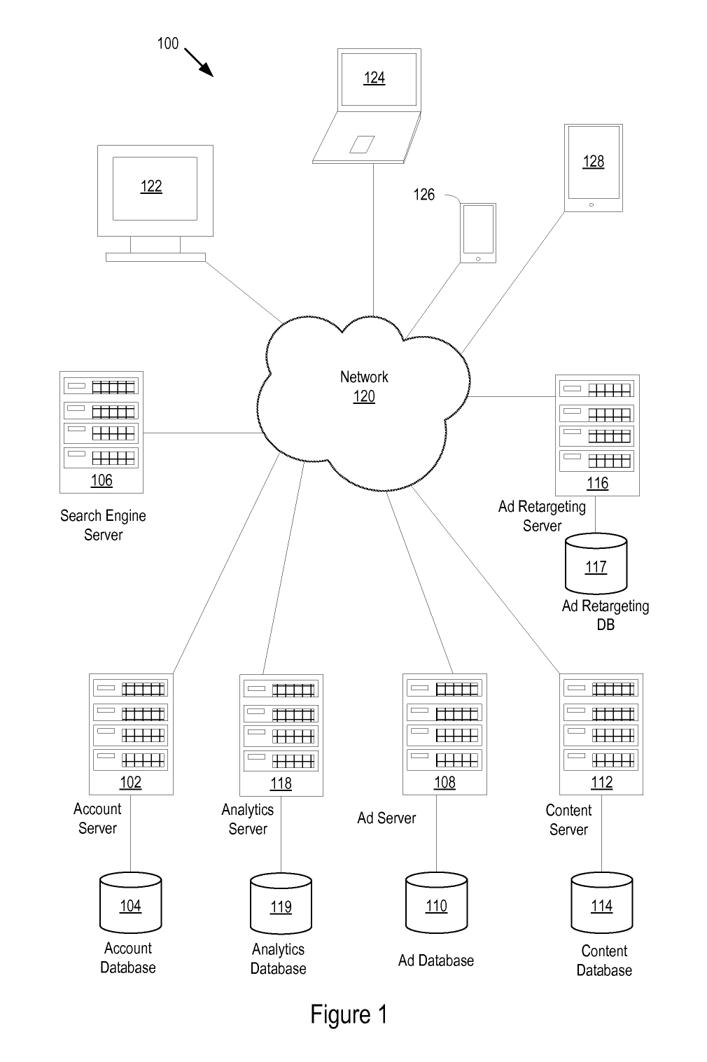

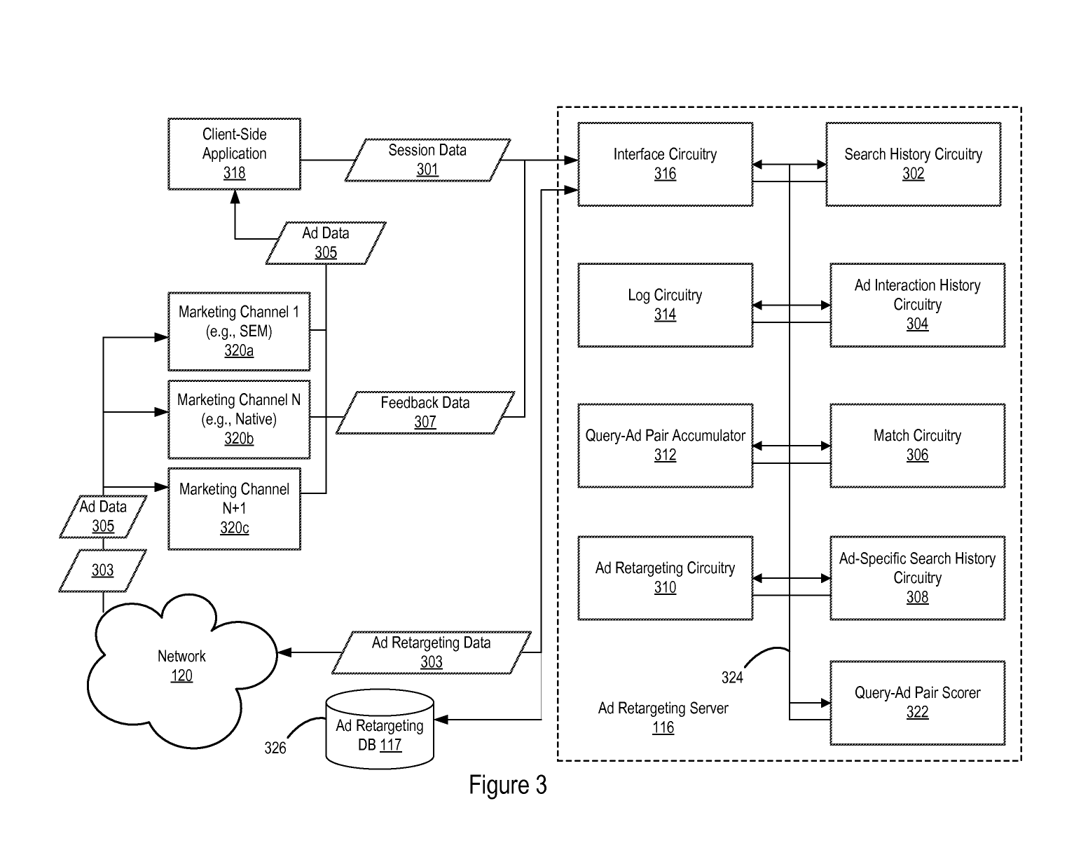

FIG. 1 illustrates a block diagram of an example information system that includes example devices of a network that can communicatively couple with an example system that can provide adaptive retargeting. The information system 100 in the example of FIG. 1 includes an account server 102, an account database 104, a search engine server 106, an ad server 108, an ad database 110, a content database 114, a content server 112, an ad retargeting server 116 (also illustrated in FIG. 3), a retargeting database 117 (also illustrated in FIG. 3), an analytics server 118, and an analytics database 119. The aforementioned servers and databases can be communicatively coupled over a network 120. The network 120 may be a computer network. The aforementioned servers may each be one or more server computers that may include computer software and/or hardware.

The information system 100 may be accessible over the network 120 by advertiser devices and audience devices, which may be desktop computers (such as device 122), laptop computers (such as device 124), smartphones (such as device 126), and tablet computers (such as device 128). An audience device can be a user device that presents online advertisements, such as a device that presents online advertisements to a retargeted audience member. In various examples of such an online information system, users may search for and obtain content from sources over the network 120, such as obtaining content from the search engine server 106, the ad server 108, the ad database 110, the content server 112, and the content database 114. Advertisers may provide advertisements for placement on online properties, such as web pages, and other communications sent over the network to audience devices. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. Also, examples include analytics data related to their ads and associated content and user interactions with the aforementioned. In an example, the analytics data may be in the form of one or more sketches, such as in the form of a sketch per audience segment, segment combination, or at least part of a campaign. A sketch can be a category represented by a data structure or a complex value, such as a hash. A sketch can include limits, and co-limits. A model of the sketch in a category C can be a functor M:D→C, which takes each specified cone to a limit cone in C and each specified co-cone to a co-limit co-cone in C. See http://en.wikipedia.org/wiki/Sketch_(mathematics). Besides individual users, groups of users, such as audience segments and segment combinations, may be targeted (such as retargeted) by the systems and operations described herein, and targeting data may be in the form of one or more sketches.

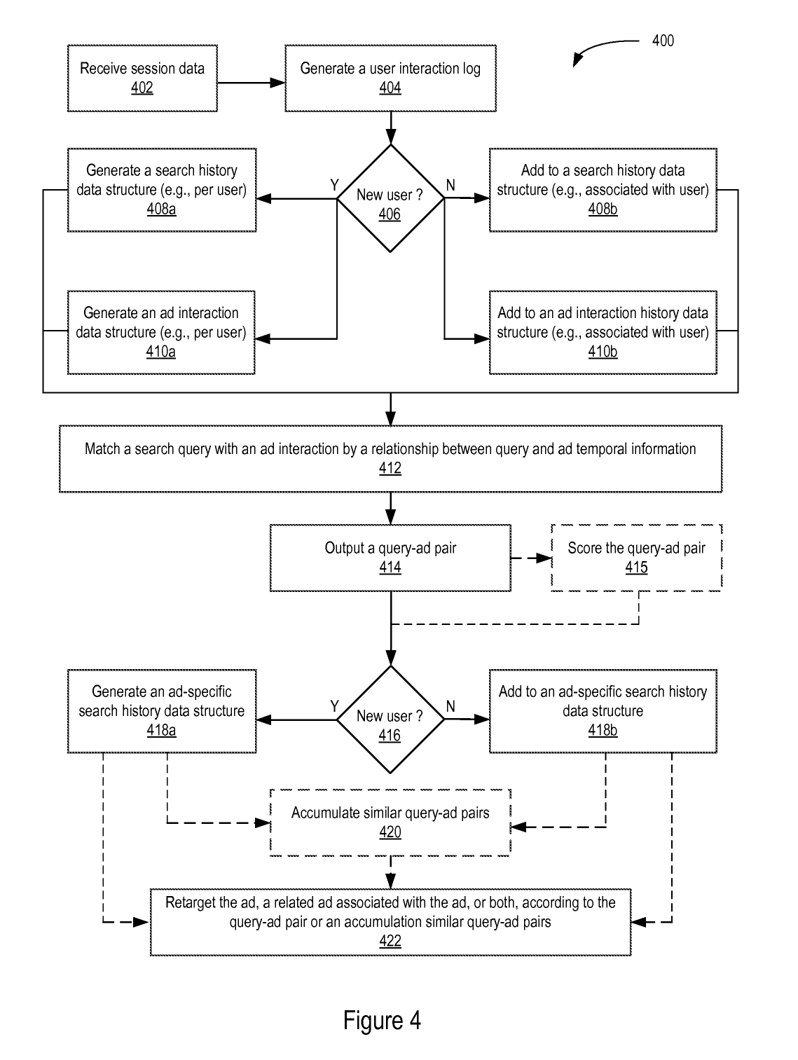

The account information may also include ad booking information (such as ad booking data 412 of FIG. 4), and such booking information may be communicated to the ad retargeting server 116 for processing. This booking information can include requests by advertisers to retarget one or more of their advertisements. Feedback regarding success of adaptive ad retargeting can be fed back to the account server 102 or a user interface of the account server, and influence the booking of ads such as the costs of requesting retargeting.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser. The advertiser front end may be a program, application, or software routine that forms a user interface. In a particular example, the advertiser front end is accessible as a website with electronic properties that an accessing advertiser may view on an advertiser device, such as one of the devices 122-128 when logged on by an advertiser. The advertiser may view and edit account data and advertisement data, such as ad booking data including requests to retarget ads, using the advertiser front end. After editing the advertising data, the account data may then be saved to the account database 104. In an example, an advertiser may only have an option to request retargeting of an ad, in general; however, in such as case and on the backend, requesting retargeting may include a request to execute adaptive retargeting for the ad.

Also, in an example, adaptive retargeting logic and strategies may be viewed in real time using the advertiser front end. The advertiser front end may be a client-side application. A script and/or applet may be a part of this front end and may render access points for requesting adaptive retargeting for one or more ads, viewing adaptive retargeting plans, or any combination thereof. In an example, this front end may include a graphical display of fields for placing bids on ad slots and adaptive retargeting. The front end, via the script and/or applet, can request the requesting adaptive retargeting for one or more ads, viewing adaptive retargeting plans, or any combination thereof. The information can then be displayed, such as displayed according to the script and/or applet.

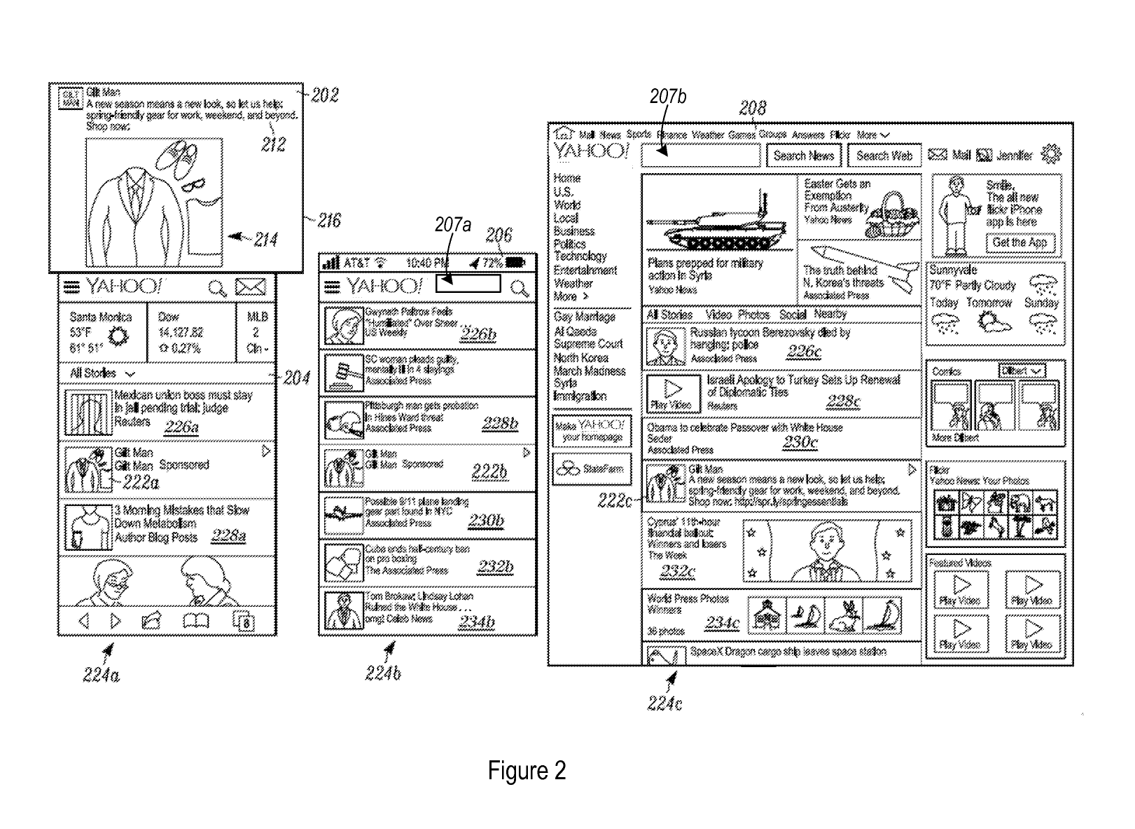

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices over the network 120. An audience client device may communicate a user query to the search engine server 106, such a communication can be included in session data, such as session data 301 in FIG. 3. For example, a query entered into a query entry box, such as boxes 207a or 207b of FIG. 2, can be communicated to the search engine server 106. The search engine server 106 locates matching information using a suitable protocol or algorithm and returns information to the audience client device, such as in the form of ads or content. The information inputted and/or outputted by these devices may be logged in data logs and communicated to the ad retargeting server 116 and/or the analytics server 118 for processing, via the network 120.

The search engine server 106 may be designed to help users and potential audience members find information located on the Internet or an intranet. In an example, the search engine server 106 may also provide to the audience client device over the network 120 an electronic property, such as a web page, with content, including search results, information matching the context of a user inquiry, links to other network destinations, or information and files of information of interest to a user operating the audience client device, as well as a stream or web page of content items and advertisement items selected for display to the user. This information provided by the search engine server 106 may also be logged, and such logs may be communicated to the ad retargeting server 116 and/or the analytics server 118 for processing. Once processed into corresponding retargeting data (such as ad retargeting data 303 in FIG. 3) and/or analytics data, such data can be input for executing adaptive retargeting, such as executing retargeting on one or more advertising marketing channels (such as marketing channels 320a-320c in FIG. 3). The analytics data may include analytics associated with user demographics and user interactions with ads and online properties associated with targeted ads. The retargeting data, which includes adaptive retargeting data, is explained in detail herein.

The search engine server 106 may enable a device, such as an advertiser client device or an audience client device, to search for files of interest using a search query. Typically, the search engine server 106 may be accessed by a client device (such as the devices 122-128) via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 operates to serve advertisements to audience devices, and the ad server can serve advertisements (such as via ad data such as ad data 305 in FIG. 3) in one or more marketing channels (such as marketing channels 320a-320c) according to retargeting data (such as ad retargeting data 303). An advertisement may include text data, graphic data, image data, video data, or audio data. Advertisements may also include data defining advertisement information that may be of interest to a user of an audience device. The advertisements (such as in appended header sections) may also include respective audience targeting information (such as retargeting information) or ad campaign information, such as information on audience segments and adaptive retargeting. An advertisement may further include data defining links to other online properties reachable through the network 120. In an example, the aforementioned audience targeting and the other data associated with an ad may be logged in data logs and such logs may be communicated to the analytics server 118 for processing to relieve resources of the ad retargeting server 116. Once processed into corresponding analytics data and/or retargeting data, such data can be input for directing ad placement and targeting, such direction with respect to audience member targeting, spatial placement, temporal placement, marketing channel placement, or any combination thereof.

For online service providers, advertisements may be displayed on electronic properties resulting from a user-defined search based, at least in part, upon search terms. With the system described herein, those search terms can be integrated with adaptive retargeting to optimize the advertisements displayed. Advertising may be beneficial to users, advertisers, or web portals if displayed advertisements are relevant to audience segments, segment combinations, or at least parts of campaigns. Aspects such as audience segments may be derived from adaptive retargeting techniques. Such techniques can derive corresponding audience segments to subsequently target relevant advertising to audience members of such segments. In an example, user intentions and targeting data related to segments or campaigns may be logged in data logs and such logs may be communicated to the ad retargeting server 116 and/or the analytics server 118 for processing. Once processed into corresponding data, such data can be input for directing ad placement and targeting.

Beside adaptive retargeting (which is described in detail herein), another approach to presenting targeted advertisements (which may be combined with adaptive retargeting) includes employing demographic characteristics (such as age, income, sex, occupation, etc.) for predicting user behavior, such as by group. Advertisements may be presented to users in a targeted audience based, at least in part, upon predicted user behavior. Corresponding targeting data, such as demographic data and psychographic data (which can include adaptive retargeting data), may be logged in data logs (such as by log circuitry 314 in FIG. 3) and such logs may be processed by the ad retargeting server 116 or communicated to the analytics server 118 for processing to relieve resources of the retargeting server. Once processed into corresponding data, such data can be input for directing ad placement and targeting.

Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases or ad clicks, for example. An identified correlation may be used to target and retarget potential purchasers or at least users that are likely to at least interact with the targeted ad. The aforementioned profile-type targeting data may be logged in data logs (such as by log circuitry 314) and such logs may be processed by the ad retargeting server 116 or communicated to the analytics server 118 for processing to relieve resources of the retargeting server. Once processed into corresponding data, such data can be input for directing ad placement and targeting.

Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data may be logged in data logs and such logs may be communicated to the analytics server 118 for processing. Once processed into corresponding analytics data, such data can be input for determining retargeting. Each of the aforementioned approaches to ad targeting may be included exclusively or combined with other techniques, and such approaches may be directed through online marketing channels (such as channels 320a-320c).

The ad server 108 includes logic and data operative to format the advertisement data for communication to an audience member device, which may be any of the devices 122-128. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs and such logs may be communicated to the ad retargeting server 116 and/or the analytics server 118 for processing. Once processed into corresponding data, such data can be input for directing ad placement and targeting.

The advertising data (such as ad data 305) may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned ad formatting and pricing data may be logged in data logs and such logs may be communicated to the ad retargeting server 116 and/or the analytics server 118 for processing. Once processed into corresponding data, such data can be input for directing ad placement and targeting.

Further, the ad server 108 is in data communication with the network 120. The ad server 108 communicates ad data and other information to devices over the network 120. This information may include advertisement data communicated to an audience device. This information may also include advertisement data and other information communicated with an advertiser device. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the ad retargeting server 116, the analytics server 118, and/or the account server 102. This information can be input for the determining of retargeting data.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device. In viewing and editing the advertising data, adjustments to retargeting may be determined and presented upon editing of the advertising data, so that a publisher can view how changes affect retargeting strategy and plans.

The ad server 108 may be one or more servers. Alternatively, the ad server 108 may be a computer program, instructions, and/or software code stored on a computer-readable storage medium that runs on one or more processors of one or more servers. The ad server 108 may access information about ad items either from the ad database 110 or from another location accessible over the network 120.

The content server 112 includes logic and data operative to format content data for communication to the audience device. The content server 112 can provide content items or links to such items to the analytics server 118 or the ad retargeting server 116 to associate with direction of ad placement and targeting. For example, content items and links may be matched to corresponding data. The matching may be complex and may be based on historical information related to particular users and/or audience segments.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data may be logged in data logs and such logs may be communicated to the ad retargeting server 116 and/or the analytics server 118 for processing. Once processed into corresponding data, such data can be input for directing ad placement and targeting.

In an example, the content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs and such logs may be communicated to the ad retargeting server 116 and/or the analytics server 118 for processing. Once processed into corresponding data, such data can be input for directing ad placement and targeting.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

An advertiser or audience client device, which may be any one of the device 122-128, includes a data processing device that may access the information system 100 over the network 120. The advertiser or audience client device is operative to interact over the network 120 with any of the servers or databases described herein. The client device may implement a client-side application for viewing electronic properties and submitting user requests. The client device may communicate data to the information system 100, including data defining electronic properties and other information. The client device may receive communications from the information system 100, including data defining electronic properties and advertising creatives. The aforementioned interactions and information may be logged in data logs and such logs may be communicated to the ad retargeting server 116 and/or the analytics server 118 for processing. Once processed into corresponding data, such data can be input for directing ad placement and targeting.

In an example, content providers may access the information system 100 with content provider devices that are generally analogous to the advertiser devices in structure and function. The content provider devices provide access to content data in the content database 114, for example.

An audience client device, which may be any of the devices 122-128, includes a data processing device that may access the information system 100 over the network 120. The audience client device is operative to interact over the network 120 with the search engine server 106, the ad server 108, the content server 112, the ad retargeting server 116, and the analytics server 118. The audience client device may implement a client-side application for viewing electronic content and submitting user requests. A user operating the audience client device may enter a search request and communicate the search request to the information system 100. The search request is processed by the search engine and search results are returned to the audience client device. The aforementioned interactions and information may be logged in data logs and such logs may be communicated to the ad retargeting server 116 and/or the analytics server 118 for processing. Once processed into corresponding data, such data can be input for directing ad placement and targeting.

In other examples, a user of the audience client device may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device. The aforementioned interactions and information may be logged in data logs and such logs may be communicated to the ad retargeting server 116 and/or the analytics server 118 for processing. Once processed into corresponding data, such data can be input for directing ad placement and targeting.

An advertiser client device and an audience client device operate as a client device when accessing information on the information system 100. A client device, such as any of the devices 122-128, may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities. At least some of the features, capabilities, and interactions with the aforementioned may be logged in data logs and such logs may be communicated to the ad retargeting server 116 and/or the analytics server 118 for processing. Once processed into corresponding data, such data can be input for directing ad placement and targeting.

Also, the disclosed methods and systems may be implemented at least partially in a cloud-computing environment, at least partially in a server, at least partially in a client device, or in any combination thereof.

FIG. 2 illustrates displayed ad items and content items of example screens rendered by client-side applications. Each of the example screens or parts of the example screens may be associated with one or more marketing channels (such as the marketing channels 320a-320c). For example, streams 224a, 224b, and 224c, may be associated with a native advertising channel and/or a search engine marketing channel. The content items and ad items displayed may be provided by the search engine server 106, the ad server 108, or the content server 112. User interactions with the ad items and content items can be tracked and logged in data logs (such as by the log circuitry 314), and such logs may be communicated to the ad retargeting server 116 and/or the analytics server 118 for processing. Once processed into corresponding data, such data can be input for directing ad placement and targeting.

In FIG. 2, a display ad 202 is illustrated as displayed on a variety of displays including a mobile web device display 204, a mobile application display 206 and a personal computer display 208. The mobile web device display 204 may be shown on the display screen of a smart phone, such as the device 126. The mobile application display 206 may be shown on the display screen of a tablet computer, such as the device 128. The personal computer display 208 may be displayed on the display screen of a personal computer (PC), such as the desktop computer 122 or the laptop computer 124.

The display ad 202 is shown in FIG. 2 formatted for display on an audience device but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable. Such reformatting may be logged in data logs and such logs may be communicated to the ad retargeting server 116 and/or the analytics server 118 for processing. Once processed into corresponding data, such data can be input for directing ad placement and targeting.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers. However, these content items may include advertising components. Each of the streams 224a, 224b, and 224c may include a number of content items and advertising items.

In an example, the streams 224a, 224b, and 224c may be arranged to appear to the user to be an endless sequence of items, so that as a user, of an audience device on which one of the streams 224a, 224b, or 224c is displayed, scrolls the display, a seemingly endless sequence of items appears in the displayed stream. The scrolling can occur via the scroll bars, for example, or by other known manipulations, such as a user dragging his or her finger downward or upward over a touch screen displaying the streams 224a, 224b, or 224c. To enhance the apparent endless sequence of items so that the items display quicker from manipulations by the user, the items can be cached by a local cache and/or a remote cache associated with the client-side application or the page view. Data corresponding to these example interactions and techniques may be communicated to the ad retargeting server 116 and/or the analytics server 118 for processing. Once processed into corresponding data, such data can be input for directing ad placement and targeting.

The content items positioned in any of streams 224a, 224b, and 224c may include news items, business-related items, sports-related items, etc. Further, in addition to textual or graphical content, the content items of a stream may include other data as well, such as audio and video data or applications. Each content item may include text, graphics, other data, and a link to additional information. Clicking or otherwise selecting the link re-directs the browser on the client device to an electronic property referred to as a landing page that contains the additional information. The clicking or otherwise selecting of the link, the re-direction to the landing page, the landing page, and the additional information, for example, can each be tracked, and then the data associated with the tracking can be logged in data logs, and such logs may be communicated to the ad retargeting server 116 and/or the analytics server 118 for processing. Once processed into corresponding data, such data can be input for directing ad placement and targeting.

Stream ads like the advertising items 222a, 222b, and 222c may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the client device to an electronic property referred to as a landing page. The clicking or otherwise selecting of the link, the re-direction to the landing page, the landing page, and the additional information, for example, can each be tracked, and then the data associated with the tracking can be logged in data logs, and such logs may be communicated to the ad retargeting server 116 and/or the analytics server 118 for processing. Once processed into corresponding data, such data can be input for directing ad placement and targeting.

While the example streams 224a, 224b, and 224c are shown with a single visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. Also, slotting may be according to corresponding ad retargeting data (such as the ad retargeting data 303).

FIG. 3 illustrates a block diagram of example aspects of a system, such as the system in FIG. 1, which can provide adaptive retargeting. For example, FIG. 3 illustrates circuitries included in and/or communicatively coupled with the ad retargeting server 116 (also illustrated in FIG. 1). Each of the circuitries may be hosted by one or more servers, such as one or more of the servers of FIG. 1. The circuitries in FIG. 3 include search history circuitry 302, ad interaction history circuitry 304, match circuitry 306, ad-specific search history circuitry 308, ad retargeting circuitry 310, query-ad pair accumulator circuitry 312, log circuitry 314, interface circuitry 316, client-side circuitry 318, marketing channel circuitries 320a-320c, and query-ad pair score circuitry 322. Each of the circuitries can be communicatively coupled with each other. For example, the circuitries 302, 304, 306, 308, 310, 312, 314, 316, and 322 may be communicatively coupled via a bus 324. Also, these circuitries and the bus may be part of the ad retargeting server 116, for example. Also, these circuitries may be communicatively coupled with other circuitries and/or themselves over a network, such as network 120 illustrated in FIG. 1. For example, circuitries of the ad retargeting servers 116 may be communicatively coupled to the client-side circuitry 318 and the marketing channel circuitries 320a-320c over the network 120. In such an example, the client-side circuitry 318 may be a part of any one of the client devices 122-128. The marketing channel circuitries 320a-320c each may be part of any one or more of the servers illustrated in FIG. 1. Additionally or alternatively, the circuitries 302, 304, 306, 308, 310, 312, 314, 316, and 322 may be part of any one or more of the servers illustrated in FIG. 1.

FIG. 3 illustrates the ad retargeting server 116 receiving session data 301 via its interface circuitry 316. The session data 301 may be communicated from the client-side application 318. In an example, the session data 301, which may include user and application session data associated with the client-side application run by the client-side application circuitry 318, may be received directly from the client-side application circuitry over the network or from user interaction logs stored on servers, such as the analytics server 118.

The interface circuitry 316 may also output ad retargeting data 303, which may be communicated to an ad retargeting database (such as the ad retargeting database 117) or over the network 120 to servers hosting the marketing channels 320a-320c. Also, through the network 120, such as by the ad server 108, ad data 305 along with the retargeting data 303 may be communicated to the marketing channels and back to the client-side application 318. The client-side application 318 may use the ad data 305 to render corresponding retargeted advertisements. The marking channels 320a-320c may use the ad retargeting data 303 to direct the use of the ad data 305 by the client-side application 318. Further, respective analytics, retargeting data, ad data, or any combination thereof may be communicated back to the ad targeting server 116 via the interface circuitry 316, such as in the form of feedback data 307. The feedback data 307 may enhance the ad retargeting data 303 outputted by the ad retargeting server 116. Also, as depicted in FIG. 3, each circuitry of the ad retargeting server 116 can provide input and feedback to the other circuitries of the ad retargeting server, and to other parts of the system such as any one or more of the servers illustrated by FIG. 1.

In example, a webpage can provide a search tool, a content stream (such as where selecting an item in the stream results in an online presentation of corresponding content), and other sources of online generated revenue, such as advertisements. In FIG. 3, the marketing channels 320a-320b may each include one or more of these technologies and sources of revenue. In such examples, adaptive retargeting operations may be associated with the webpage or a collection of related webpages including the aforementioned elements. In another example, the content provider providing content listed in the depicted webpage also can provide the search engine services and the marketing channel services from any parts of the system illustrated in FIGS. 1 and 3. Additionally or alternatively, the system of these figures may exchange information with other information systems, such as other systems providing one or more of content, advertising services, and online searching technologies. These other systems may include cloud computing systems and social media systems (such as an online social networking service).

In the system illustrated in FIG. 3, the search history circuitry 302 can be configured to generate or add to a search history data structure using user interaction logs. The search history data structure can include a record of a plurality of search queries and can be stored in a database such as the retargeting database 117. The ad interaction history circuitry 304 can be configured to generate or add to an ad interaction history data structure using the user interaction logs. The ad interaction history data structure can include a record of a plurality of ad interactions and can be stored in a database such as the retargeting database 117. A record of a search query in such user interaction logs can include a keyword associated with the search query, a query session identifier associated with a session hosting an instance of the search query, a query timestamp associated with execution of the instance of the search query, or any combination thereof. A record of an ad interaction in such logs can include an indication of a type of user interaction with the ad, an ad session identifier associated with a session hosting an instance of the ad interaction, a timestamp associated with execution of the instance of the ad interaction, or any combination thereof. Query temporal information can include the query session identifier, the query timestamp, or both, and the ad temporal information can include the ad session identifier, the ad timestamp, or both.

The match circuitry 306 can be configured to match a search query of the plurality of search queries with an ad interaction of the plurality of ad interactions according to a relationship between query temporal information associated with the search query and ad temporal information associated with the ad interaction. The query and the ad interaction can be associated with a particular user or audience segment, for example. The match circuitry 306 can also be configured to output a query-ad pair associated with the user according to the match. The query-ad pair can include an indication of a pairing between the query and an ad corresponding to the ad interaction. In an example, the relationship between the query temporal information and the ad temporal information occurs due to the query session identifier matching the ad session identifier, a difference between the query timestamp and the ad timestamp not exceeding a timing threshold, or both. Also, the timing threshold can be determined manually, automatically, or manually in part and automatically in part.

The ad-specific search history circuitry 308 can be configured to generate or add to a query-ad pair data structure using the query-ad pair. The query-ad pair data structure can include a record of the query-ad pair and can be stored in a database such as the retargeting database 117.

The ad retargeting circuitry 310 can be configured to retarget the ad, a related ad associated with the ad, or both, according to the query-ad pair, the aforementioned match, or both. The retargeting of the ad can occur within a search engine marketing channel, such as a search engine marketing channel (e.g., marketing channel 320a), a native marketing channel (e.g., marketing channel 320b), another type of marketing channel (e.g., marketing channel 320c), or any combination thereof. The retargeting can be with respect to a user or a group of users such as an audience segment or segment combination.

In an example, the user may be a first user and the ad retargeting circuitry may be further configured to retarget the ad by selecting the ad for delivery to a second user that has entered the search query, has requested content associated with the search query, or both. In such an example, the second user may have not interacted with the ad prior to the retargeting of the ad. Also, the delivery of the ad to the second user may occur along with a search result page resulting from the second user entering the query. Additionally or alternatively, the delivery of the ad to the second user may occur within a page view referred by a search result page resulting from the second user entering the query. The referral may occur directly or indirectly, such as directly from a link in the search results or through a link on a landing page that resulted from a referral of the search results. Also, the delivery of the ad to the second user may occur within a page view of a different browser session than one in which the second user enters the search query. Also, the delivery of the ad to the second user can occur independently of a search result page resulting from the second user entering the query.

The query-ad pair accumulator 312 can be configured to accumulate the query-ad pair with a plurality of similar query-ad pairs associated with other users or audience segments, which can result in an accumulation of similar query-ad pairs for the user and the other users or the audience segment and the other segments. The query-ad pair accumulator 312 can also be configured to generate or add to a corresponding accumulation data structure. The accumulation data structure can include a record of the query-ad pair accumulations and can be stored in a database such as the retargeting database 117. In such examples, the ad retargeting circuitry can also be configured to retarget the ad, the related ad associated with the ad, or both, according to the accumulation provided by the query-ad pair accumulator 312. Also, the retargeting can occur when an amount of query-ad pairs in an accumulation exceeds an accumulation threshold. The accumulation threshold can be determined manually, automatically, or manually in part and automatically in part.

Also, as mentioned, the ad retargeting server 116 includes the interface circuitry 316, which can be configured to receive session data 301, such as browser and user session data associated with a web browser session. The ad retargeting server 116 can also include log circuitry 314 that can be configured to generate the user interaction logs according to the session data. Additionally or alternatively, the session data can be provided by any one or more of the servers illustrated in FIG. 1, such as the analytics server 118 or the content server 112.

In yet another example, the match circuitry 306 can be further configured to score the relationship between the query temporal information and the ad temporal information, and the ad retargeting circuitry 310 can be further configured to position the retargeting temporally, spatially, or both, according to the score of the relationship. Additionally or alternatively, and as illustrated in FIG. 3, the ad retargeting server 116 can include the query-ad pair scorer circuitry 322 that can be configured to score the query-ad pair. Either way, query-ad pair scoring can occur according to a match between query and ad interaction session identifiers, a difference between a query timestamp and an ad interaction timestamp, or both, and the ad retargeting circuitry can be configured to position the retargeting temporally, spatially, or both, relative to retargeting of other ads, according to the score of the query-ad pair.

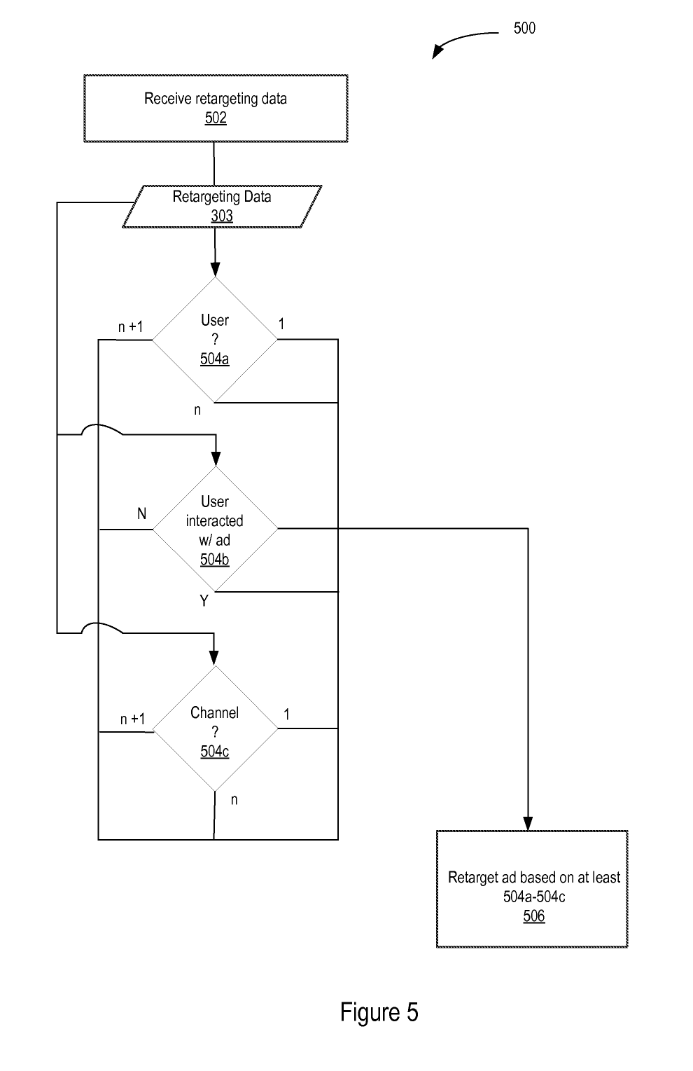

FIGS. 4 and 5 illustrate example operations performed by a system, such as the system in FIGS. 1 and 3, that can provide adaptive retargeting.

FIG. 4, at 402, illustrates the receiving of session data (such as session data 301 being received by the ad retargeting server 116 in FIG. 3). From the session data, a user interaction log can be generated at 404, such as by the log circuitry 314.

At 406, the system can determine whether a user is new or not. For example, the system can determine whether a user is new to an advertising or content network or not. When the user is new, the system, such as by the search history circuitry 302, can generate a search history data structure at 408a. Additionally or alternatively, the system can generate a search history data structure corresponding to a new audience segment. When the user is not new, the system, such as by the search history circuitry 302, can add to a search history data structure at 408b. Likewise, the system can add to a search history data structure corresponding to an existing audience segment.

Also, when the user is new, the system, such as by the ad interaction history circuitry 304, can generate an ad interaction history data structure at 410a. Additionally or alternatively, the system can generate an ad interaction history data structure corresponding to a new audience segment. When the user is not new, the system, such as by the ad interaction history circuitry 304, can add to an ad interaction history data structure at 410b. Likewise, the system can add to an ad interaction history data structure corresponding to an existing audience segment.

At 412, the system, such as by the match circuitry 306, can match a search query with an ad interaction by a relationship between query and ad interaction temporal information. This can result in the outputting of a query-ad pair at 414. The query-ad pair can be relevant to a particular user or an audience segment. Additionally, in an example, the system can score the query-ad pair, such as by the query-ad pair scorer circuitry 322. After the matching at 412, it can be determined again whether the user (or segment) is new at 416, and then accordingly, the system can generate (such as by the ad-specific search history circuitry 308) an ad-specific search history data structure at 418a or add to an existing ad-specific search history data structure at 418b.

Optionally, depending on the configuration of the system, the system (such as by the query-ad pair accumulator circuitry 312) can accumulate similar query-ad pairs and even score such accumulations at 420. Whether or not the accumulation occurs, the system (such as by the ad retargeting circuitry 310), at 422, can retarget the ad, a related ad associated with the ad, or both. Such retargeting can occur according to the query-ad pair or an accumulation of similar query-ad pairs, depending on the configuration of the system.

FIG. 5, at 502, illustrates the receiving of ad retargeting data. The receiving of the retargeting data can be from the ad retargeting server 116, through an operation similar to the retargeting at 422 illustrated in FIG. 4, or both. Additionally or alternatively, the retargeting data can be received by any one or more of the servers illustrated in FIG. 1, which can perform any one or more of the operations illustrated in FIGS. 4 and 5.

The ad retargeting data (such as the ad retargeting data illustrated in FIG. 3) can provide instructions and direction for delivery of ads. For example, the retargeting data can include instructions regarding direction for delivery of ads for a user or segment depending on the configuration of the system. This can occur once a user or segment is identified for retargeting of an ad, such as at 504a. Also, a server (such as any one or more of the servers in FIG. 1) can determine whether the identified user or segment interacted with the ad, at 504b. Also, such a server can determine which marketing channel should be used for delivering the ad, at 504c. This information determined or identified by the server can be used by the server to retarget the ad, at 506. For example, where a particular user is identified and that first user has already viewed a given ad through a first marketing channel, the ad according to this information can be retargeted by the server to a second but similar user through a second marketing channel. This is one example of how the ad could be retargeted according to the retargeting data, at 506.

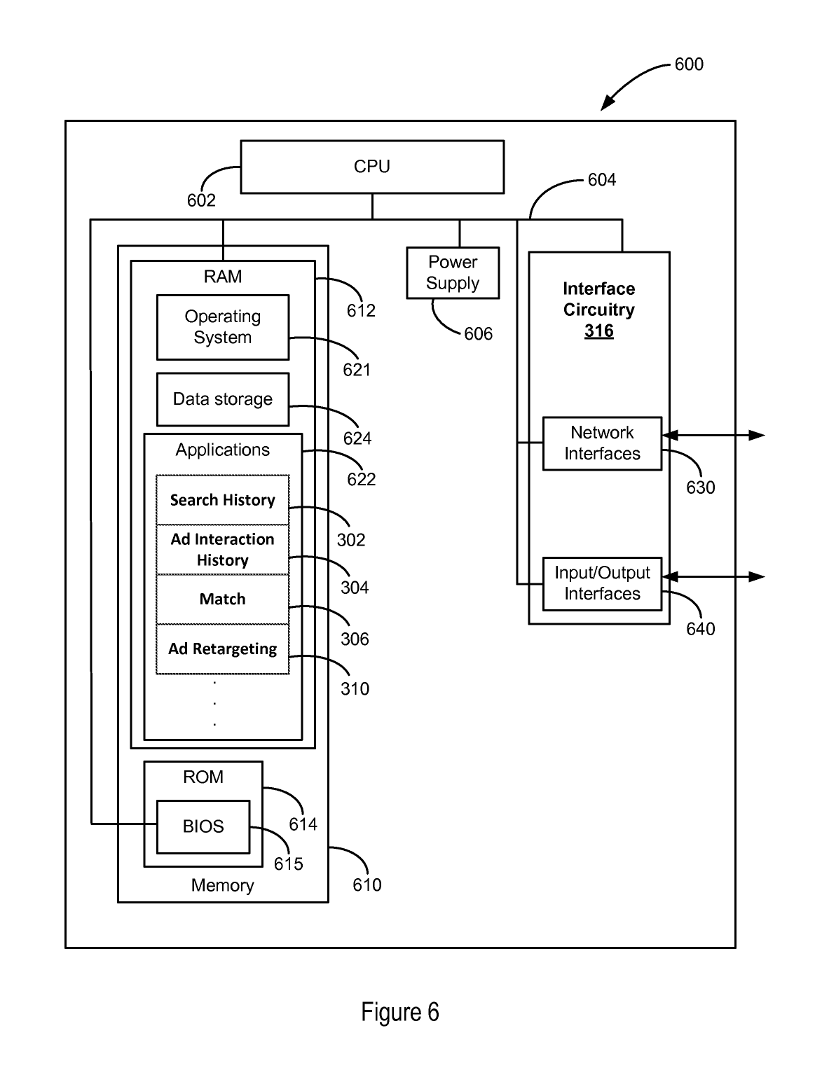

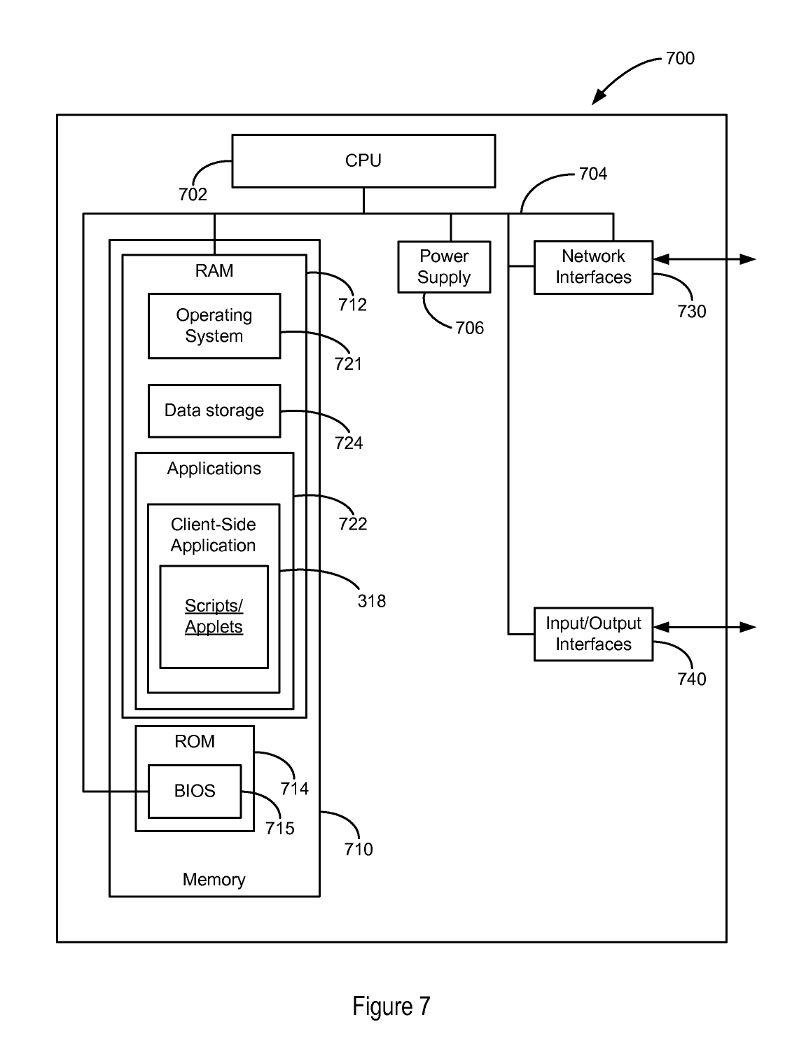

FIGS. 6 and 7 are block diagrams of example electronic devices that can implement aspects of and related to example systems that can provide adaptive retargeting. FIG. 6 illustrates a server, such as the ad retargeting server 116. FIG. 7 illustrates a client device, such as any one of the client devices 122-128 illustrated in FIG. 1 or a device that hosts the client-side application circuitry 318 illustrated in FIG. 3.

The electronic device 600 can include a CPU 602, memory 610, a power supply 606, and input/output components, such as network interfaces 630 and input/output interfaces 640, and a communication bus 604 that connects the aforementioned elements of the electronic device. The network interfaces 630 can include a receiver and a transmitter (or a transceiver), and an antenna for wireless communications. The network interfaces 630 can also include at least part of the interface circuitry 316 in FIG. 3. The CPU 602 can be any type of data processing device, such as a central processing unit (CPU). Also, for example, the CPU 602 can be central processing logic.

The memory 610, which can include random access memory (RAM) 612 or read-only memory (ROM) 614, can be enabled by memory devices. The RAM 612 can store data and instructions defining an operating system 621, data storage 624, and applications 622, such as applications implemented through hardware including the search history circuitry 302, the ad interaction history circuitry 304, the matcher 306, and the ad retargeting circuitry 310. The applications 622 may include hardware (such as circuitry and/or microprocessors), firmware, software, or any combination thereof. The ROM 614 can include basic input/output system (BIOS) 615 of the electronic device 600. The memory 610 may include a non-transitory medium executable by the CPU.

The power supply 606 contains power components, and facilitates supply and management of power to the electronic device 600. The input/output components can include at least part of the interface circuitry 316 for facilitating communication between any components of the electronic device 600, components of external devices (such as components of other devices of the information system 100), and end users. For example, such components can include a network card that is an integration of a receiver, a transmitter, and I/O interfaces, such as input/output interfaces 640. The I/O components, such as I/O interfaces 640, can include user interfaces such as monitors, keyboards, touchscreens, microphones, and speakers. Further, some of the I/O components, such as I/O interfaces 640, and the bus 604 can facilitate communication between components of the electronic device 600, and can ease processing performed by the CPU 602.

The electronic device 600 can send and receive signals, such as via a wired or wireless network, or may be capable of processing or storing signals, such as in memory as physical memory states, and may, therefore, operate as a server. The device 600 can include a single server, dedicated rack-mounted servers, desktop computers, laptop computers, set top boxes, integrated devices combining various features, such as two or more features of the foregoing devices, or the like.

The electronic device 700 can include a central processing unit (CPU) 702, memory 710, a power supply 706, and input/output components, such as network interfaces 730 and input/output interfaces 740, and a communication bus 704 that connects the aforementioned elements of the electronic device. The network interfaces 730 can include a receiver and a transmitter (or a transceiver), and an antenna for wireless communications. The CPU 702 can be any type of data processing device, such as a central processing unit (CPU). Also, for example, the CPU 702 can be central processing logic; central processing logic may include hardware (such as circuitry and/or microprocessors), firmware, software and/or combinations of each to perform functions or actions, and/or to cause a function or action from another component. Also, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 710, which can include random access memory (RAM) 712 or read-only memory (ROM) 714, can be enabled by memory devices, such as a primary (directly accessible by the CPU) and/or a secondary (indirectly accessible by the CPU) storage device (such as flash memory, magnetic disk, optical disk). The memory 710 may include a non-transitory medium executable by the CPU.

The RAM 712 can store data and instructions defining an operating system 721, data storage 724, and applications 722, including the client-side application 318 in FIG. 3. The applications 722 may include hardware (such as circuitry and/or microprocessors), firmware, software, or any combination thereof. Example content provided by an application, such as the client-side application 318, may include text, images, audio, video, or the like, which may be processed in the form of physical signals, such as electrical signals, for example, or may be stored in memory, as physical states, for example.

The ROM 714 can include basic input/output system (BIOS) 715 of the electronic device 700. The power supply 706 contains power components, and facilitates supply and management of power to the electronic device 700. The input/output components can include various types of interfaces for facilitating communication between components of the electronic device 700, components of external devices (such as components of other devices of the information system 100), and end users. For example, such components can include a network card that is an integration of a receiver, a transmitter, and I/O interfaces, such as input/output interfaces 740. A network card, for example, can facilitate wired or wireless communication with other devices of a network. In cases of wireless communication, an antenna can facilitate such communication. The I/O components, such as I/O interfaces 740, can include user interfaces such as monitors, keyboards, touchscreens, microphones, and speakers. Further, some of the I/O components, such as I/O interfaces 740, and the bus 704 can facilitate communication between components of the electronic device 700, and can ease processing performed by the CPU 702.

1. A system, comprising:
search history circuitry, configured to generate or add to a search history data structure using a user interaction logs, the search history data structure including a record of a plurality of search queries;
ad interaction history circuitry, configured to generate or add to an ad interaction history data structure using the user interaction logs, the ad interaction history data structure including a record of a plurality of ad interactions;
match circuitry, configured to match a search query of the plurality of search queries with an ad interaction of the plurality of ad interactions according to a relationship between query temporal information associated with the search query and ad temporal information associated with the ad interaction; and
ad retargeting circuitry, configured to retarget an ad of the ad interaction, a related ad associated with the ad, or both, according to the match.

2. The system of claim 1, wherein the match circuitry is further configured to output a query-ad pair associated with a user of the ad interaction according to the match, the query-ad pair including an indication of a pairing between the query and an ad corresponding to the ad interaction.

3. The system of claim 2, further comprising ad-specific search history circuitry, configured to generate or add to a query-ad pair data structure using the query-ad pair, the query-ad pair data structure including a record of the query-ad pair.

4. The system of claim 2, further comprising a query-ad pair accumulator, configured to accumulate the query-ad pair with a plurality of similar query-ad pairs associated with other users, which results in an accumulation of similar query-ad pairs for the user and the other users, and wherein the ad retargeting circuitry is further configured to retarget the ad, the related ad associated with the ad, or both, according to the accumulation.

5. The system of claim 4, wherein the retargeting occurs when an amount of query-ad pairs in the accumulation exceeds an accumulation threshold, the accumulation threshold being determined manually, automatically, or manually in part and automatically in part.

6. The system of claim 1, wherein the retargeting occurs within a search engine marketing channel.

7. The system of claim 1, wherein the retargeting occurs within a native marketing channel.

8. The system of claim 1, wherein the retargeting includes redelivery of the ad to a user of the ad interaction within a search engine marketing channel, a native marketing channel, or both.

9. The system of claim 1, further comprising:
interface circuitry configured to receive user session data; and
log circuitry, configured to generate the user interaction logs according to the user session data.

10. The system of claim 1, wherein the match circuitry is further configured to score the relationship between the query temporal information and the ad temporal information, and wherein the ad retargeting circuitry is further configured to position the retargeting of the ad temporally, spatially, or both, according to the score of the relationship.

11. A method comprising,
generating or adding to, by search history circuitry, a search history data structure using a user interaction logs, the search history data structure including a record of a plurality of search queries;
generating or adding to, by ad interaction history circuitry, an ad interaction history data structure using the user interaction logs, the ad interaction history data structure including a record of a plurality of ad interactions;
matching, by match circuitry, a search query of the plurality of search queries with an ad interaction of the plurality of ad interactions according to a relationship between query temporal information associated with the search query and ad temporal information associated with the ad interaction, the query and the ad interaction associated with a first user;
outputting, by the match circuitry, a query-ad pair associated with the user according to the match, the query-ad pair including an indication of a pairing between the query and an ad corresponding to the ad interaction; and
retargeting, by ad retargeting circuitry, the ad by selecting the ad for delivery to a second user that has entered the search query, has requested content associated with the search query, or both.

12. The method of claim 11, wherein the second user has not interacted with the ad prior to the retargeting of the ad.

13. The method of claim 11, wherein the delivery of the ad to the second user occurs along with a search result page resulting from the second user entering the query.

14. The method of claim 11, wherein the delivery of the ad to the second user occurs within a page view referred by a search result page resulting from the second user entering the query, the referral occurring directly or indirectly.

15. The method of claim 11, wherein the delivery of the ad to the second user occurs within a page view of a different browser session than one in which the second user enters the search query.

16. The method of claim 11, wherein the delivery of the ad to the second user occurs independently of a search result page resulting from the second user entering the query.

17. A system, comprising:
search history circuitry, configured to generate or add to a search history data structure using a user interaction logs, the search history data structure including a record of a plurality of search queries;
ad interaction history circuitry, configured to generate or add to an ad interaction history data structure using the user interaction logs, the ad interaction history data structure including a record of a plurality of ad interactions;
match circuitry, configured to:
match a search query of the plurality of search queries with an ad interaction of the plurality of ad interactions according to a relationship between query temporal information associated with the search query and ad temporal information associated with the ad interaction, the query and the ad interaction associated with a user; and
output a query-ad pair associated with the user according to the match, the query-ad pair including an indication of a pairing between the query and an ad corresponding to the ad interaction; and
ad retargeting circuitry, configured to retarget the ad, a related ad associated with the ad, or both, according to the query-ad pair.

18. The system of claim 17,
wherein a record of the search query includes a keyword associated with the search query, a query session identifier associated with a session hosting an instance of the search query, a query timestamp associated with execution of the instance of the search query, or any combination thereof,
wherein a record of the ad interaction includes an indication of a type of user interaction with the ad, an ad session identifier associated with a session hosting an instance of the ad interaction, an ad interaction timestamp associated with execution of the instance of the ad interaction, or any combination thereof,
wherein the query temporal information includes the query session identifier, the query timestamp, or both, and
wherein the ad temporal information includes the ad session identifier, the ad interaction timestamp, or both.

19. The system of claim 18, wherein the relationship between the query temporal information and the ad temporal information occurs due to the query session identifier matching the ad session identifier, a difference between the query timestamp and the ad interaction timestamp not exceeding a timing threshold, or both, the timing threshold being determined manually, automatically, or manually in part and automatically in part.

20. The system of claim 19, further comprising a query-ad pair scorer circuitry, configured to score the query-ad pair according to the match between the session identifiers, the difference, or both, and wherein the ad retargeting circuitry is further configured to position the retargeting temporally, spatially, or both, relative to retargeting of other ads, according to the score of the query-ad pair.
